(19) United States
(12) Patent Application Publication
(10) Pub. No.: US 2006/0137944 A1
(43) Pub. Date: Jun. 29, 2006

(54) Drum brake shoe and backplate made from constrained layer viscoelastic laminates

(75) Inventor: Eric Denys, Ann Arbor, MI (US)

Correspondence Address: Quinn Law Group PLLC, 39555 Orchard Hill Place Suite # 520, Novi, MI, 48375, US

(73) Assignee: MATERIAL SCIENCES CORPORATION

(21) Appl. No.: 11/021,613

(22) Filed: Dec. 23, 2004

(51) Int. Cl. F16D 65/04

(52) U.S. Cl. 188/250 E; 188/250 B; 188/379

(57) ABSTRACT

The present invention provides a drum brake shoe assembly with exceptional vibration an noise damping characteristics. In one embodiment both the web and the rim of the brake shoe are constructed of constrained layer viscoelastic laminate material. Another embodiment of the invention provides a drum brake backplate made from a constrained layer viscoelastic laminate material with exceptional damping characteristics.

### TECHNICAL FIELD

The present invention relates to the damping of unwanted noise producing vibrations of a drum brake system by the use of constrained layer viscoelastic laminate materials, particularly the use of a laminated steel material comprising a viscoelastic layer constrained by two layers of steel in the manufacture of the rim and web of the brake shoe and the drum brake backplate.

### BACKGROUND OF THE INVENTION

The present invention relates to a drum brake assembly of a vehicle. The drum brake system has changed little since it was first installed on vehicles. Drum brake systems are found on a wide range of vehicles from aircraft to automobiles. Drum brakes have more parts than disc brakes and are therefore more difficult to service, but they are less expensive to manufacture, can easily incorporate an emergency brake system, and provide adequate braking force. For the foregoing reasons, manufacturers tend to favor the use of drum brakes at the rear wheels of most modern automobiles. Almost certainly, for as long as there have been drum brakes in general use, there have been objectionable noises which engineers have tried to eliminate.

A brief description of the operation of a drum brake system may help to understand the problem that is to be solved by the present invention. The typical drum brake system has many movable parts that must work in concert to effect a vehicle stop. In a typical drum brake assembly there is a backplate that mounts to the axle in a rear mounted configuration. Attached to this backing plate is a hydraulic wheel cylinder which houses two internal pistons. These pistons move oppositely outward from the center of the wheel cylinder when the vehicle brake pedal is depressed which, in turn, force metal rods to act upon the brake shoes that are movably mounted with respect to the backplate. The brake shoes are allowed to pivot at the end opposite the wheel cylinder. This pivot point in modern drum brakes is typically defined by what is called a “star wheel” adjuster which allows for brake adjustment to compensate for brake shoe wear. The brake shoes consist of a friction element, often referred to as a liner, and a rim to which the liner is attached. A plate, commonly referred to as the web, is oriented perpendicularly to the rim of the shoe. The web provides structural support to the brake shoe to prevent shoe collapse under severe braking. When force is applied to the brake shoe by the wheel cylinder, the shoes are forced outward and engage the cylindrical surface defined by the inside diameter of the brake drum. It is this frictional engagement that provides the braking force to slow the vehicle. The operation of a drum brake system may result in the vibration of the brake shoes. These vibrations may result in the production of an unpleasant noise commonly referred to as “brake squeal” and may lead to customer annoyance in severe cases. “Brake squeal” may be further amplified by the backplate of the drum brake system. This backplate may act as a soundboard and cause a marginal “brake squeal” to become unacceptable.

Inventors have attempted to alleviate the noise problem that may be encountered with drum brakes.

U.S. Pat. No. 5,099,967 issued to Lang on Mar. 31, 1992, discloses a drum brake assembly that utilizes a layer of viscoelastic damping material sandwiched between two metal plates and mounted in various techniques to what the inventor refers to as the abutment. This device may help to dampen the vibrations of the brake shoe, however modern brakes typically employ a “star wheel” adjuster in place of an abutment. This device may therefore be difficult to implement in modern systems.

### SUMMARY OF THE INVENTION

Accordingly, the present invention incorporates a constrained layer viscoelastic laminate material in the rim and web of a brake shoe as well as the backplate of the drum brake system. This laminate material comprises at least one viscoelastic layer constrained, either by mechanical fastening or bonding, by at least two constraining layers with a modulus sufficient to provide the necessary stiffness for the desired application.

As described previously, the operation of a conventional drum brake may result in vibration of the brake shoes. This is an undesirable phenomenon since the vibration may result in the production of an unpleasant noise commonly referred to as “brake squeal” which may lead to customer annoyance in severe cases. The present invention will dampen these vibrations by forcing the viscoelastic layer of the constrained layer viscoelastic laminate into shear, thereby, dissipating the vibrational energy and noise energy in the form of heat energy.

The brake shoe of the present invention has the advantage over other shoes in that the damping layer is located intimately to the source of vibration. This allows the bulk of the vibration to be damped prior to diffusion to other components whose vibration may not be so easily attenuated. The damping effectiveness of the viscoelastic material is also a function of the total surface area of the material. Another beneficial aspect of the present invention is that the total surface area of the viscoelastic layer is maximized by distributing it over the entire area of the rim and web of the brake shoe.

If the “brake squeal” is not completely dissipated by the viscoelastic layer contained within the brake shoe, the residual noise may be attenuated by incorporating a drum brake backplate made from constrained layer viscoelastic laminate material. The brake drum and the backplate fit closely together to protect the internal components of the brake system. A backplate made of constrained layer viscoelastic laminate material would act as a last line of defense in attenuating any brake noise that may seek to radiate from the drum braking system and ultimately to the observer's ear.

The preferred embodiment of the present invention is simple and cost effective to implement. A commercially available constrained layer viscoelastic laminate material is available from Material Sciences Corporation of Farmington Hills, Mich. under the trade name Quiet Steel®. This laminate material can be stamped; therefore, a manufacturer can easily implement the use of this material in the manufacture of the web and rim of the brake shoe as well as the backplate with little impact on tooling.

Accordingly, the present invention is a drum brake assembly comprising at least one brake shoe having a rim formed from a first constrained layer viscoelastic laminate material, including at least one viscoelastic layer and at least two constraining layers. A web is provided in a substantially perpendicular relation to the rim and is formed from a second constrained layer viscoelastic laminate material, including at least one viscoelastic layer and at least two constraining layers. The drum brake assembly may also include a backplate mounted with respect to the brake shoe. The back plate may also be formed from a third constrained layer viscoelastic laminate material, including at least one viscoelastic layer and at least two constraining layers. The first, second, and third viscoelastic laminate material may be the same laminate or may be respectively different. The two constraining layers of the first, second, and third constrained layer viscoelastic laminate material need not be the same material. In the preferred embodiment the constraining layers for the first, second, and third constrained layer viscoelastic laminate material will be formed from steel.

The present invention also provides a method of attenuating noise and vibrations from a drum brake assembly by forming at least a portion of one or both of the backplate and the brake shoe (web and rim) of the drum brake assembly from a constrained layer viscoelastic laminate material. The laminate being formed from at least one viscoelastic layer sandwiched between at least two constraining layers. The method further includes maximizing the total surface area of the viscoelastic layer by distributing the layer over the entire area of the portion to be formed.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a drum brake system having the brake drum removed;

FIG. 2 a perspective view of a brake shoe illustrating the laminated rim and web of the present invention; and

FIG. 3 a sectioned illustration of the drum brake system with the drum installed illustrating how the shoes engage the internal diameter of the drum and illustrating the laminated nature of the backplate of the present invention.

### DESCRIPTION OF THE PREFERRED EMBODIMENTS

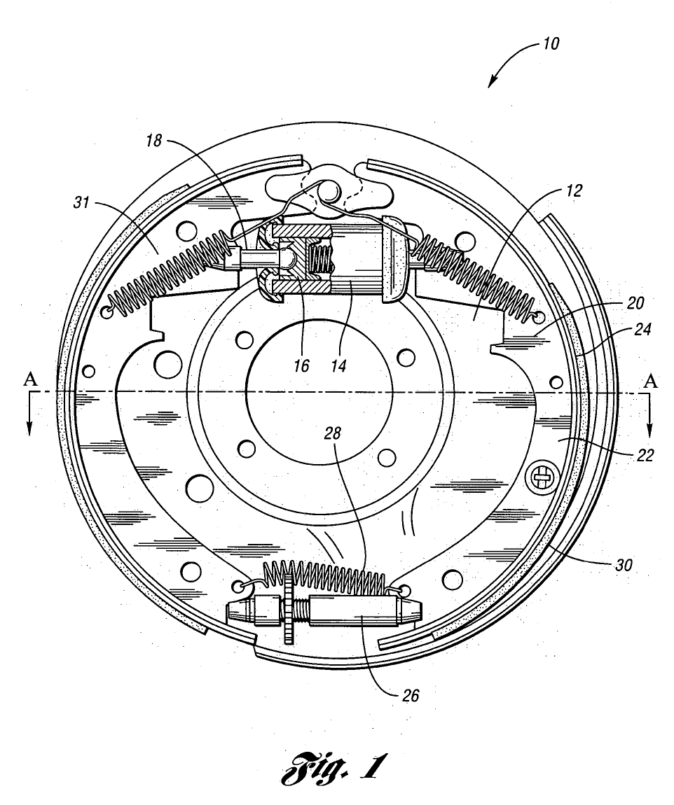

FIG. 1 is a drum brake assembly 10 (with the brake drum removed) in accordance with the present invention. While the drum brake assembly 10 shown in FIG. 1 is hydraulic in nature, the drum brake assembly 10 may be actuated by any means such as mechanical, pneumatic, electric, or hydraulic with out changing the inventive concept. An automotive hydraulic drum brake assembly 10 was chosen for this description as it is the most common system in use today.

The drum brake assembly 10 of FIG. 1 comprises a backplate 12 that rigidly mounts to an axle (not shown) in the case of rear brakes. Attached to the backplate 12 is the wheel cylinder 14 which is in hydraulic communication with the braking system of the vehicle. Upon actuation of the vehicle braking system, the wheel cylinder 14 becomes energized with hydraulic fluid. This fluid in turn forces two pistons 16 located within the wheel cylinder 14 to move oppositely outward from the center of the wheel cylinder 14. The pistons 16 in turn force rods 18 outward against the webs 20 at one extreme end of the brake shoes 22. The webs 20 are in perpendicular orientation with respect to the rim 24 of the brake shoe 22. The webs 20 provide support to the brake shoe 22 to avert collapse under severe braking. The exertion of force by the rods 18 urge the brake shoes 22 outward and to pivot about the “star wheel” 26. The “star wheel” 26 serves as an adjustment element in the drum brake assembly 10 to compensate for the wear of the brake shoes 22. The “star wheel” 26 may be either self adjusting, or manual adjusting as in FIG. 1. The brake shoes 22 are held in relation to the “star wheel” 26 by a coil spring 28. As the shoes 22 move outward, the frictional element or liner 30, which is attached to the rim 24 by bonding or mechanically fastening, engages the cylindrical surface defined by the interior diameter of the brake drum 44 (shown in FIG. 3). This frictional engagement provides the braking force necessary to slow the vehicle. The return springs 31 will pull the brake shoes 22 out of engagement with the brake drum 44 upon release of the brakes.

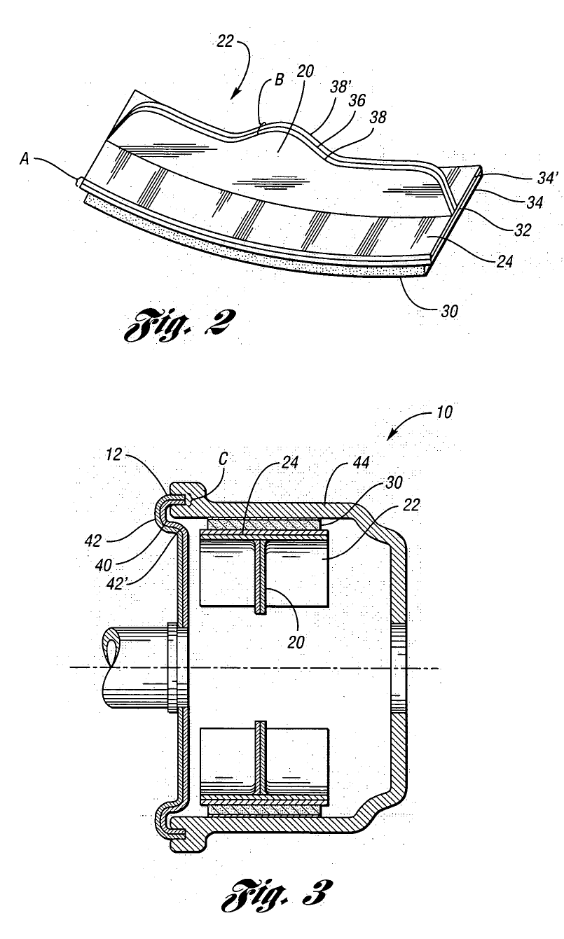

The drum brake assembly 10, when applied, converts the kinetic energy of the moving vehicle into heat and sound energy. Sound energy is an undesirable byproduct caused by vibration of the brake shoes 22 under certain braking conditions. FIG. 2 is a perspective view of a brake shoe 22 illustrating the laminated rim 24 and web 20 of the present invention. The rim 24 of the brake shoe 22 is made from a constrained layer viscoelastic laminate material, such as A. The laminate A is comprised of at least one viscoelastic layer 32 sandwiched between at least two constraining layers 34, 34′. The constraining layers 34, 34′ are formed from steel in the preferred embodiment, but may be other materials capable of providing the necessary stiffness for the application such as aluminum, magnesium, or composite materials. The web 20 of the brake shoe 22 is made from a constrained layer viscoelastic laminate material, such as B. The laminate B is comprised of at least one viscoelastic layer 36 sandwiched between at least two constraining layers 38, 38′. The constraining layers 38, 38′ are formed from steel in the preferred embodiment, but may be other materials capable of providing the necessary stiffness for the application such as aluminum, magnesium, or composite materials. The constraining layers 34, 34′, 38, and 38′ may be made from the same or different materials, geometries, or configurations. In addition, the viscoelastic layers 32, 36 may be made from the same or different materials, geometries, or configurations. This flexibility allows the brake designer great flexibility in choosing the properties of the web 20 and rim 24 most suitable to the application.

The brake shoe 22 of the present invention will dampen the vibrations of the brake shoe 22 by forcing the viscoelastic layers 32, 36 into shear, thereby, dissipating the noise producing vibrational energy as heat energy. The brake shoe 22 of the present invention has an advantage over conventional damping techniques in that the viscoelastic layers 32, 36 are located intimately to the source of vibration. It is this point where constrained layer viscoelastic laminate materials are most effective at damping vibrations. This proximity to the source of vibration will allow the bulk of the vibration to be damped prior to transmission to other components such as the “star wheel” 26, coil spring 28, or wheel cylinder 14. These transmitted vibrations may not be easy to attenuate.

The damping effectiveness of the constrained layer viscoelastic laminate material is a function of the total surface area of the viscoelastic layer. One fundamental benefit of the brake shoe 22 is that it maximizes the total surface area of the viscoelastic layer 32, 36 by distributing the viscoelastic material over the entire area of the rim 24 and web 20.

In the event that the “brake squeal” is not completely dissipated by the constrained layer viscoelastic laminate material, B and A of the web 20 and rim 24 respectively, the residual noise may be attenuated by a drum brake backplate 12 made from a constrained layer viscoelastic laminate material, such as C, as shown in FIG. 3. The laminate C is comprised of at least one viscoelastic layer 40 constrained by at least two constraining layers 42, 42′. The constraining layers 42, 42′ are formed from steel in the preferred embodiment, but may be formed from other materials capable of providing the necessary stiffness for the application such as aluminum, magnesium, or composite materials. The constraining layers 42, 42′ may be made from the same or different materials, geometries, or configurations. In addition, the viscoelastic layer 40 may be made from the same or different materials, geometries, or configurations. This flexibility allows the brake designer great flexibility in choosing the properties of the backplate 12 most suitable to the application.

As illustrated in FIG. 3, the drum 44 and the backplate 12 fit closely together, in effect, sealing internal components of the braking system 10 to the elements. Therefore, a backplate 12 made of constrained layer viscoelastic laminate material may serve as a last line of defense in damping any brake noise that may seek to radiate from the drum brake assembly 10 and ultimately to the observer's ear.

The web 20 and rim 24 of the brake shoe 22 and the backplate 12 of the brake system 10 are easily stamped from commercially available constrained layer viscoelastic laminate material such as Quiet Steel® from Material Sciences Corporation of Farmington Hills, Mich. Therefore, a manufacturer may easily implement the use of this material with little impact on tooling.

While the best modes for carrying out the invention have been described in detail, those familiar with the art to which this invention relates will recognize various alternative designs and embodiments for practicing the invention within the scope of the appended claims.

1. A drum brake assembly comprising:
at least one brake shoe having a rim formed from a first constrained layer viscoelastic laminate material, including at least one viscoelastic layer and at least two constraining layers;
a friction lining element carried by said rim; and
a web provided in substantially perpendicular relation to said rim, said web being formed from a second constrained layer viscoelastic laminate material, including at least one other viscoelastic layer and at least two other constraining layers.

2. The drum brake assembly of claim 1, further comprising a backplate mounted with respect to said at least one brake shoe.

3. The drum brake assembly of claim 2, wherein said backplate is formed from a third constrained layer viscoelastic laminate material, including at least one viscoelastic layer and at least two constraining layers.

4. The drum brake assembly of claim 1, wherein said first and second constrained layer viscoelastic laminate materials are the same.

5. The drum brake assembly of claim 1, wherein said at least two constraining layers of said first constrained layer viscoelastic laminate material are different.

6. The drum brake assembly of claim 1, wherein said at least two constraining layers of said second constrained layer viscoelastic laminate material are different.

7. The drum brake assembly of claim 3, wherein said at least two constraining layers of said third constrained layer viscoelastic laminate material are different.

8. The drum brake assembly of claim 1, wherein said at least two constraining layers of said first constrained layer viscoelastic laminate material are steel.

9. The drum brake assembly of claim 1, wherein said at least two constraining layers of said second constrained layer viscoelastic laminate material are steel.

10. The drum brake assembly of claim 3, wherein said at least two constraining layers of said third constrained layer viscoelastic laminate material are steel.

11. A drum brake assembly comprising:
at least one brake shoe having a rim formed from a first constrained layer viscoelastic laminate material including a viscoelastic layer and two constraining layers formed from steel;
a friction lining element carried by said rim;
a web provided in substantially perpendicular relation to said rim, said web being formed from a second constrained layer viscoelastic laminate material including a viscoelastic layer and two constraining layers formed from steel; and
a backplate formed from a third constrained layer viscoelastic laminate material including a viscoelastic layer and two constraining layers formed from steel.

12. A method of attenuating noise producing vibrations from a drum brake assembly having one or more elements including a drum, backplate and at least one brake shoe having a web and a rim, movable to frictionally engage said drum, the method comprising:
forming at least a portion of at least one of said backplate and said at least one shoe including both said web and said rim of from constrained layer viscoelastic laminate, including at least one viscoelastic layer and at least two constraining layers.

13. The method of claim 12, including maximizing the total surface area of said viscoelastic layer by distributing the layer over the entire area of said portion formed.

14. The method of claim 13, wherein said portion formed is the rim and web of said at least one brake shoe.

15. The method of claim 13, wherein said portion formed is the backplate.

16. The method of claim 12, wherein said forming is by stamping.
